(19) United States
(12) Patent Application Publication
(10) Pub. No.: US 2008/0077789 A1
(43) Pub. Date: Mar. 27, 2008

(54) SERVER, METHOD, AND COMPUTER PROGRAM PRODUCT FOR MEDIATING COMMUNICATION

(75) Inventor: Shunichi Gondo, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/686,637

(22) Filed: Mar. 15, 2007

(30) Foreign Application Priority Data
Sep. 26, 2006 (JP) 2006-261354

(51) Int. Cl. H04L 9/32; H04L 9/00; G06K 9/00; G06F 17/30; G06F 7/04

(52) U.S. Cl. 713/155; 726/2; 713/153

(57) ABSTRACT

An intermediate server mediates communication between a communication terminal and an authentication server for performing authentication of the communication terminal. The intermediate server includes a communication-request receiving unit that receives a communication request message for requesting the authentication server to start communication from the communication terminal; a communication mediating unit that mediates the communication between the communication terminal and the authentication server in response to the communication request message received; an authentication-state receiving unit that receives an authentication state of the communication terminal from the authentication server; and a judging unit that judges success or failure of the authentication of the communication terminal based on the authentication state received.

### CROSS-REFERENCE TO RELATED APPLICATIONS

This application is based upon and claims the benefit of priority from the prior Japanese Patent Application No. 2006-261354, filed on Sep. 26, 2006; the entire contents of which are incorporated herein by reference.

### BACKGROUND OF THE INVENTION

1. Field of the Invention

The present invention relates to a server, a method, and a computer program product for mediating communication between communication terminals and between the communication terminals and an authentication server.

2. Description of the Related Art

In recent years, the session initiation protocol (SIP) is widely known as a signaling procedure that intervenes between communication apparatuses to control and relay communication. In a method generally adopted as the conventional SIP authentication system, a transmitting apparatus transmits authentication information such as a password together with a transmission message and a receiving apparatus carries out authentication for the transmitting apparatus based on the authentication information received together with the transmission message.

For example, in transmitting a register message to an SIP proxy as the receiving apparatus, an SIP client as the transmitting apparatus transmits the register message together with authentication information that guarantees that the transmitting apparatus is a regular SIP client. On the other hand, first, the SIP proxy performs authentication based on authentication data received on the register message and confirms that the transmitting apparatus is the regular SIP client. Then, according to success or failure of the authentication, the SIP proxy determines propriety of registration processing requested in the register message.

In short, the purpose of the conventional SIP authentication system is to check, in the receiving apparatus, propriety of processing in the receiving apparatus requested in a message from the transmitting apparatus. Therefore, the transmitting apparatus needs to transmit authentication information simultaneously with the message. The authentication information is exchanged in communication between the transmitting apparatus and the receiving apparatus (e.g., the SIP client and the SIP proxy) together with the message. Therefore, the authentication information is limited to one that does not hinder a communication message and communication processing. When an amount of data of the authentication information increases, an amount of communication data between the transmitting apparatus and the receiving apparatus also increases.

On the other hand, once an authentication state is established, the authentication state continues until the authentication state is released according to an explicit request or a term of validity expires. This is because, in the first place, authentication is performed for judging propriety of processing requested in a message. Therefore, validity of the processing requested in the message is equivalent to validity of the authentication state. For example, in the case of registration processing, the authentication state is valid while a certain registration is valid.

A communication mediating server such as an SIP proxy changes a behavior based on an authentication state of a communication apparatus in response to a message from the communication apparatus. Actually, it is necessary to change the behavior based on a registration state of the communication apparatus. This means that an authentication server and the communication mediating server cannot detect a change in the authentication state of the communication apparatus. Therefore, for example, when the SIP proxy immediately detects a change in an authentication state of the SIP client, the SIP client as the transmitting apparatus needs to frequently repeat registration processing.

As a method of detecting a change in an authentication state of a communication apparatus, JP-A 2005-99980 (KOKAI) proposed a technology for invalidating an authentication state at an appropriate opportunity by periodically checking a connection state of a communication apparatus from a communication mediating server.

However, in the method proposed by JP-A 2005-99980 (KOKAI), when a change in the authentication state of the SIP client is immediately detected, processing loads on the SIP proxy increases. Therefore, the SIP proxy needs to frequently repeat message transmission for checking a connection state of the SIP client.

Moreover, when authentication using biological information and image information is performed for improvement of security and the like, an amount of data of authentication information used for the authentication is large. Thus, the processing loads on the SIP proxy further increases because of not only an increase in frequency of check but also an increase in an amount of communication data.

### SUMMARY OF THE INVENTION

According to one aspect of the present invention, an intermediate server that mediates communication between a communication terminal and an authentication server for performing authentication of the communication terminal, the intermediate server includes a communication-request receiving unit that receives a communication request message for requesting the authentication server to start communication from the communication terminal; a communication mediating unit that mediates the communication between the communication terminal and the authentication server in response to the communication request message received; an authentication-state receiving unit that receives an authentication state of the communication terminal from the authentication server; and a judging unit that judges success or failure of the authentication of the communication terminal based on the authentication state received.

According to another aspect of the present invention, a communication mediating method for mediating communication between a communication terminal and an authentication server that performs authentication of the communication terminal, the method includes receiving a communication request message for requesting the authentication server to start communication from the communication terminal; mediating the communication between the communication terminal and the authentication server in response to the communication request message received; receiving an authentication state of the communication terminal from the authentication server; and judging success or failure of the authentication of the communication terminal based on the authentication state received.

A computer program product according to still another aspect of the present invention causes a computer to perform the method according to the present invention.

### BRIEF DESCRIPTION OF THE DRAWINGS

FIG. 1 is a diagram for explaining a characteristic of a communication system according to a first embodiment of the present invention;

FIG. 2 is a block diagram of a structure of the communication system according to the first embodiment;

FIG. 3 is a diagram for explaining an example of a data structure of a registration information table;

FIG. 4 is a diagram for explaining an example of a data structure of a connection information table;

FIG. 5 is diagram for explaining an example of a data structure of an authentication state table;

FIG. 6 is a flowchart of a flow of overall communication mediation processing according to the first embodiment;

FIG. 7 is a flowchart of a flow of overall signaling request mediation processing according to the first embodiment;

FIG. 8 is a diagram for explaining a characteristic of a communication system according to a second embodiment of the present invention;

FIG. 9 is a block diagram of a structure of a communication system according to the second embodiment;

FIG. 10 is a flowchart of a flow of overall communication mediation processing according to the second embodiment; and

FIG. 11 is a diagram for explaining a hardware configuration of an intermediate server according to the first or the second embodiment.

### DETAILED DESCRIPTION OF THE INVENTION

Exemplary embodiments of the present invention are explained in detail below with reference to the accompanying drawings.

An intermediate server according to a first embodiment receives a result of authentication processing from an authentication server and judges an authentication state of a communication terminal. The authentication processing is executed between the authentication server and the communication terminal by an arbitrary method and at an arbitrary frequency using communication established according to an INVITE request of an SIP.

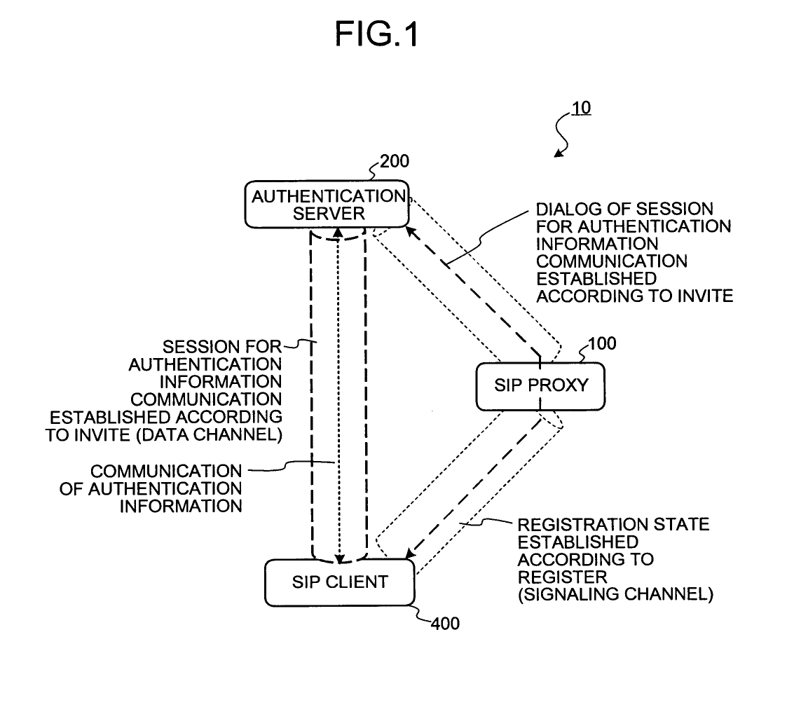

As shown in FIG. 1, a communication system 10 includes an SIP proxy 100 as an intermediate server, an authentication server 200, and an SIP client 400 as a communication terminal. A plurality of authentication servers 200 and a plurality of SIP clients 400 may be provided. These apparatuses are connected to one another via networks such as the Internet and a local area network (LAN).

As shown in the figure, in this embodiment, the SIP client 400 transmits a registration request message (REGISTER) to the SIP proxy 100 and registers the SIP client 400 therein. Then, communication of authentication information is performed through a data channel established between the SIP client 400 and the authentication server 200 according to an INVITE request. The SIP proxy 100 receives an authentication state of the SIP client 400 from the authentication server 200 using a dialog established according to the INVITE request.

This makes it unnecessary to transmit the authentication information from the SIP client 400 to the SIP proxy 100 and execute authentication in the SIP proxy 100. The authentication information is communicated to perform authentication between the SIP client 400 and the authentication server 200 using communication established according to the INVITE request. Only the authentication state has to be notified from the authentication server 200 to the SIP proxy 100. This makes it possible to reduce processing loads on the SIP proxy 100.

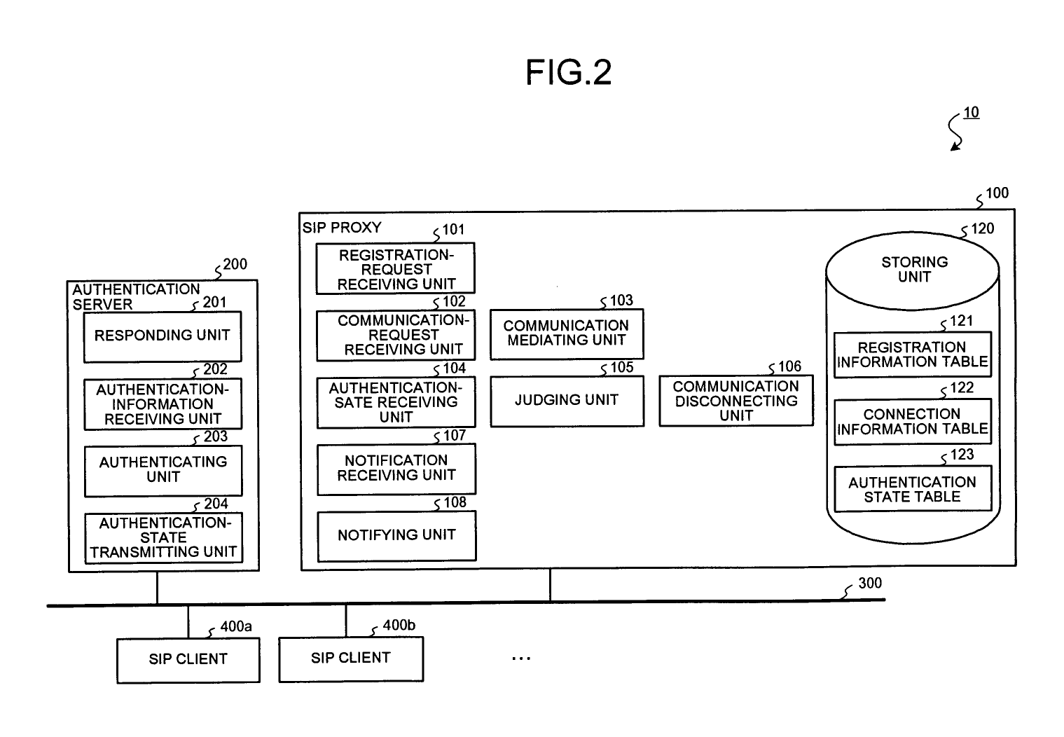

As shown in FIG. 2, in the communication system 10, the SIP proxy 100 as the intermediate server, the authentication server 200, and SIP clients 400a and 400b are connected to one another via a network 300.

The SIP clients 400a and 400b (hereinafter, collectively referred to as “SIP client 400”) are apparatuses having a client function of the SIP (SIP user agent (UA)). The SIP client 400 acquires authentication information using a keyboard, a camera, a microphone, a sensor, and the like and transmits the authentication information to the authentication server 200 to perform authentication of the SIP client 400.

The authentication server 200 performs authentication of the SIP client 400. In this embodiment, the authentication server 200 receives the authentication information from the SIP client 400 through the data channel established between the authentication server 200 and the SIP client 400 via the SIP proxy 100 according to an INVITE request and performs authentication processing.

As shown in FIG. 2, the authentication server 200 includes a responding unit 201, an authentication-information receiving unit 202, an authenticating unit 203, and an authentication-state transmitting unit 204.

The responding unit 201 returns a response to the INVITE request from the SIP client 400 via the SIP proxy 100. The INVITE request is a communication request message for requesting establishment of communication.

The authentication-information receiving unit 202 receives authentication information used for authentication from the SIP client 400. The authentication-information receiving unit 202 receives character information, image information, sound information, biological information such as a fingerprint, and the like as the authentication information from the SIP client 400 according to an authentication method adopted by the authenticating unit 203 described later.

The authenticating unit 203 performs authentication processing for the SIP client 400 using the authentication information received by the authentication-information receiving unit 202. As the authentication method adopted by the authenticating unit 203, it is possible to apply all the conventional authentication methods such as a method in which an ID and a password are used and a method in which biological information is used.

The authentication-state transmitting unit 204 transmits an authentication state of the SIP client 400 to the SIP proxy 100 with reference to a result of authentication by the authenticating unit 203. The authentication-state transmitting unit 204 may transmit the authentication state to the SIP client 400.

The authentication server 200 receives the authentication information at an arbitrary frequency and performs the authentication processing. For example, the authentication server 200 may continuously authenticate the SIP client 400.

The continuous authentication means an authentication system in which authentication is repeated, for example, at a predetermined time interval or an arbitrary time interval between the authentication server 200 and the SIP client 400. More specifically, the continuous authentication means an authentication system in which the SIP client 400 continues to send sound and images, biological information, and the like to the authentication server 200 and the authentication server 200 receives the sound and images, the biological information, and the like and authenticates the SIP client 400 at a predetermined or arbitrary time interval. Success or failure of the authentication may be directly returned from the authentication server 200 to the SIP client 400 every time the authentication is performed or at a predetermined or arbitrary time interval or may be notified from the authentication server 200 to the SIP client 400 via the SIP proxy 100.

The authentication server 200 may request the SIP client 400 to send the authentication information to the authentication server 200. The communication between the SIP client 400 and the authentication server 200 may be encoded. As an encryption method in this case, it is possible to apply all the conventional methods.

The SIP proxy 100 is an intermediate server that mediates communication between the authentication server 200 and the SIP client 400 or communication among SIP clients 400. The SIP proxy 100 uses the SIP as a protocol for the mediation of communication. The SIP proxy 100 includes a storing unit 120, a registration-request receiving unit 101, a communication-request receiving unit 102, a communication mediating unit 103, an authentication-state receiving unit 104, a judging unit 105, a communication disconnecting unit 106, a notification receiving unit 107, and a notifying unit 108.

The storing unit 120 stores various kinds of information used in mediation processing for communication by the intermediate server. The storing unit 120 may be any storage medium generally used such as a hard disk drive (HDD), an optical disk, a memory card, or a random access memory (RAM). The storing unit 120 includes a registration information table 121, a connection information table 122, and an authentication state table 123 as tables for storing the various kinds of information.

The registration information table 121 stores information on the SIP client 400 registered in the SIP proxy 100.

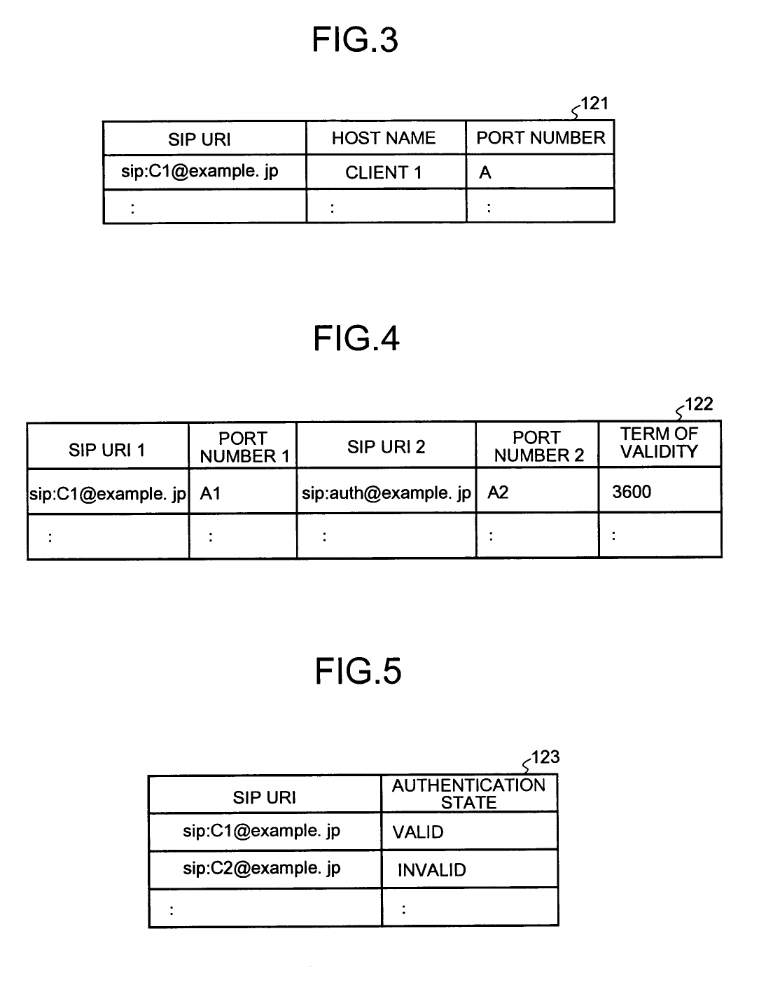

As shown in FIG. 3, the registration information table 121 stores registration information in which an SIP uniform resource identifier (URI) of the SIP client 400 registered, a host name as a name of the SIP client 400 registered, and a port number to be used are associated with one another.

The connection information table 122 stores connection information concerning communication established between the SIP clients 400 or between the SIP client 400 and the authentication server 200.

As shown in FIG. 4, the connection information table 122 stores an SIP URI1 and an SIP URI2 that are SIP URIs of the each SIP client 400, a port number 1 and a port number 2, and a term of validity of the communication established in association with one another.

The authentication state table 123 stores a state of authentication by the authentication server 200 for each SIP client 400 registered.

As shown in FIG. 5, the authentication state table 123 stores an SIP URI and an authentication state in association with each other. “Valid” representing a state in which an SIP client is authenticated by the authentication server 200 or “invalid” representing a state in which an SIP client is not authenticated by the authentication server 200 is set in the authentication state.

When the SIP client 400 is registered, “invalid” is set in the authentication state. When a notification of success in authentication is received from the authentication server 200, “valid” is set in the authentication state. Thereafter, when a notification of failure in authentication is received from the authentication server 200, “invalid” is set in the authentication state. It is also possible to set “invalid” by judging an authentication state in the SIP proxy 100 when, for example, a term of validity of connection has expired.

The registration-request receiving unit 101 receives a registration request message (a REGISTER request) transmitted from the SIP client 400. The REGISTER request is transmitted to register the SIP client 400 in the registration information table 121 and establish a connection state for performing communication after that between the SIP client 400 and the SIP proxy 100. As in the usual SIP, the REGISTER request may be accompanied by digest authentication for the purpose of authentication for the REGISTER request.

The communication-request receiving unit 102 receives an INVITE request for requesting establishment of communication to the authentication server 200 from the SIP client 400.

The communication mediating unit 103 transmits the INVITE request received to the authentication server 200 and establishes communication between the SIP client 400 and the authentication server 200 according to a response returned from the authentication server 200. When communication is established, the communication mediating unit 103 stores connection information concerning the communication established in the connection information table 122.

The authentication-state receiving unit 104 receives an authentication state of the SIP client 400 from the authentication server 200 for which the communication is established. When the authentication is successful, the authentication sever 200 transmits the INVITE request to the SIP proxy 100. Therefore, the authentication-state receiving unit 104 receives the INVITE request from the authentication server 200 as an authentication state representing the success in the authentication. When the authentication fails, the authentication server 200 transmits a BYE request to the SIP proxy 100. Thus, the authentication-state receiving unit 104 receives the BYE request as an authentication state representing the failure in the authentication.

When a notification message such as an INVITE request from the SIP client 400 to the other SIP clients 400 or the like is received, the judging unit 105 judges success or failure of authentication for the SIP client 400 with reference to the authentication state stored in the authentication state table 123.

When it is judged by the judging unit 105 that the authentication of the SIP client 400 is invalid, the communication disconnecting unit 106 disconnects the communication established for the SIP client 400.

After the authentication by the authentication server 200, the notification receiving unit 107 receives a notification message concerning communication such as an INVITE request from the authenticated SIP client 400 to the other SIP clients 400 or the like. Besides INVITE, the notification receiving unit 107 can receive all messages treated in the SIP such as SUBSCRIBE, MESSAGE, and BYE as notification messages.

The notifying unit 108 transmits various notification messages to the SIP client 400 (a first notifying unit). For example, the notifying unit 108 notifies the other SIP clients 400 designated as notification destinations of the notification message received by the notification receiving unit 107. The notifying unit 108 may notify the SIP client 400 of the authentication state received from the authentication server 200 (a second notifying unit). Moreover, after the SIP client 400 is registered, the notifying unit 108 may notify the registered SIP client 400 of information on the usable authentication server 200 (a third notifying unit).

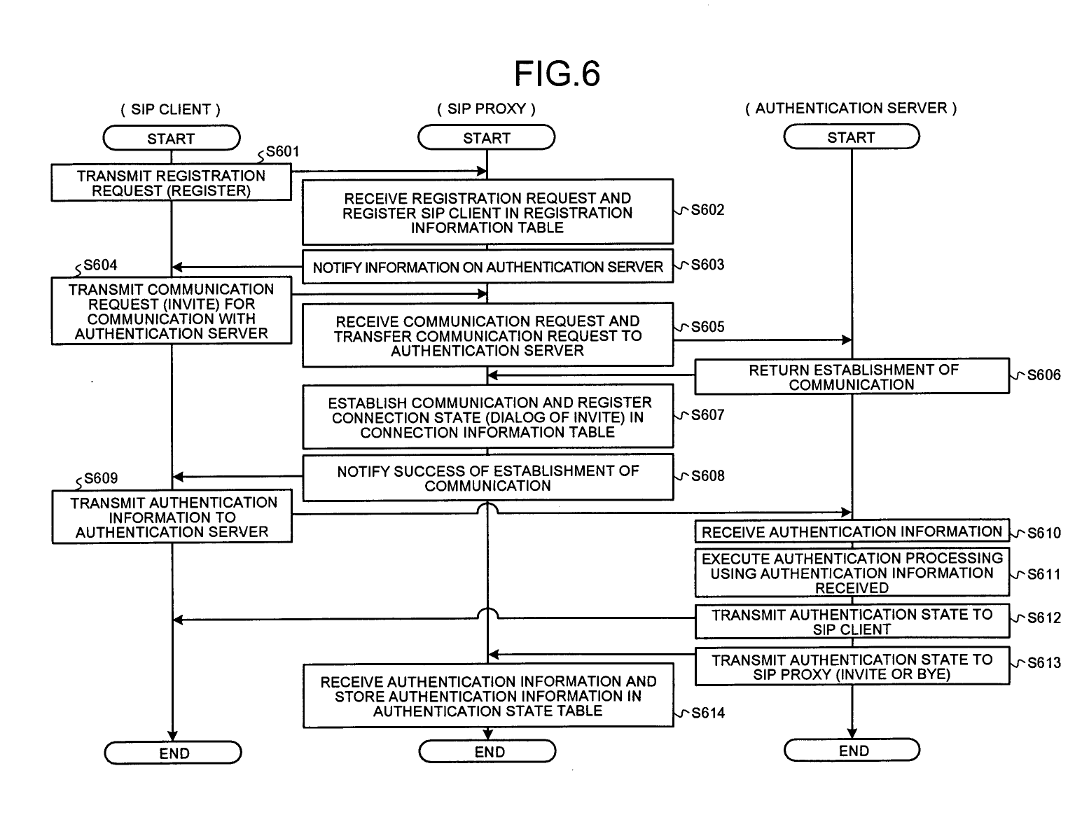

Communication mediation processing by the SIP proxy 100 according to the first embodiment constituted as described above is explained with reference to FIG. 6.

First, the SIP client 400 transmits a REGISTER request to the SIP proxy 100 as a registration request message (step S601).

The registration-request receiving unit 101 of the SIP proxy 100 receives the registration request message and registers the SIP client 400 in the registration information table 121 (step S602). At the same time, the registration-request receiving unit 101 may store an authentication state of the SIP client 400 in the authentication state table 123. At this point, the authentication state is set as “invalid”.

In this embodiment, unlike the usual SIP, after the REGISTER request is accepted and the SIP client 400 is registered, a signaling request for a communication state received by the SIP proxy 100 from the SIP client 400 is limited to a signaling request from the SIP client 400 to the authentication server 200. Signaling requests for a connection state from the other SIP clients 400 or the like to the SIP client 400 are not accepted. This is because it is necessary to perform authentication using the authentication server 200 and receive a notification of a result of the authentication before signaling communication with the other apparatuses.

The notifying unit 108 transmits information on the usable authentication server 200 to the SIP client 400 (step S603). When the SIP client 400 has acquired the information on the authentication server 200, this step may be omitted.

The SIP client 400 transmits an INVITE request to the SIP proxy 100 as a communication request message for establishing communication between the SIP client 400 and the authentication server 200 (step S604).

The communication-request receiving unit 102 of the SIP proxy 100 receives the INVITE request from the SIP client 400 and transfers the INVITE request to the authentication server 200 (step S605).

The responding unit 201 of the authentication server 200 receives the INVITE request and returns a response to the INVITE request to the SIP proxy 100 (step S606). Here, the responding unit 201 transmits a response for allowing establishment of communication.

The communication mediating unit 103 of the SIP proxy 100 establishes communication between the SIP client 400 and the authentication server 200 and registers a connection state of the communication established, i.e., connection information concerning a dialog established according to the INVITE request in the connection information table 122 (step S607). The SIP client 400 and the authentication server 200 can directly communicate with each other according to this dialog.

The notifying unit 108 notifies the SIP client 400 that the communication has been successfully established (step S608).

The SIP client 400 transmits authentication information to the authentication server 200 using the dialog established in this way according to the direct communication between the SIP client 400 and the authentication server 200 (step S609).

The authentication-information receiving unit 202 of the authentication server 200 receives the authentication information from the SIP client 400 (step S610). The authenticating unit 203 executes authentication processing using the authentication information received (step S611). The authentication-state transmitting unit 204 transmits an authentication state to the SIP client 400 (step S612). The authentication-state transmitting unit 204 transmits the authentication state to the SIP proxy 100 (step S613).

In this case, when the authentication is successful, the authentication-state transmitting unit 204 transmits an INVITE request (a re-INVITE request) for updating the dialog. When the authentication fails, the authentication-state transmitting unit 204 transmits a BYE request to the SIP proxy 100.

The authentication-state receiving unit 104 of the SIP proxy 100 receives the authentication state and stores “valid” or “invalid” in the authentication-state table 123 as an authentication state according to success or failure of the authentication (step S614).

Although not shown in the figure, when the authentication fails, the communication disconnecting unit 106 deletes connection information concerning the SIP client 400, for which the authentication fails, from the connection information table 122 to discard the dialog. Consequently, communication from the SIP client 400 or communication to the SIP client 400 is restricted. The SIP proxy 100 may transmit the authentication state received and an authentication state based on the authentication state received to the SIP client 400.

Thereafter, the processing from step S609 to step S614 is repeatedly executed at an arbitrary interval and frequency. For example, it is possible to execute notification of the authentication state by the authentication server 200 at any timing such as an arbitrary interval set in the authentication server or a point when the authentication server 200 detects a change in the authentication state other than at the time of first authentication immediately after the dialog is established. When the authentication server 200 cannot acquire the authentication information from the SIP client 400 during a fixed time set in the authentication server 200, the authentication server 200 may perform an operation same as the operation performed when authentication fails.

When a method of transmitting the INVITE request at the time of success and transmitting the BYE request at the time of failure is adopted as a method of notifying the authentication state, it is possible to minimize an amount of communication. Instead, the authentication state may be notified to the SIP proxy 100 and the SIP client 400 using MESSAGE, NOTIFY, and the like.

As described above, in this embodiment, when communication is established using the SIP, the authentication processing is not performed in the SIP proxy 100 as the intermediate server that mediates the establishment of communication but is performed in the authentication server 200 according to the authentication information transmitted via the communication established. It is possible to judge an authentication state of the SIP client 400 by notifying the SIP proxy 100 of a result of the authentication processing. Since the SIP proxy 100 only receives information on the authentication state from the authentication server 200, it is possible to reduce processing loads on the SIP proxy 100 regardless of a method of realizing the authentication processing executed in the authentication server 200.

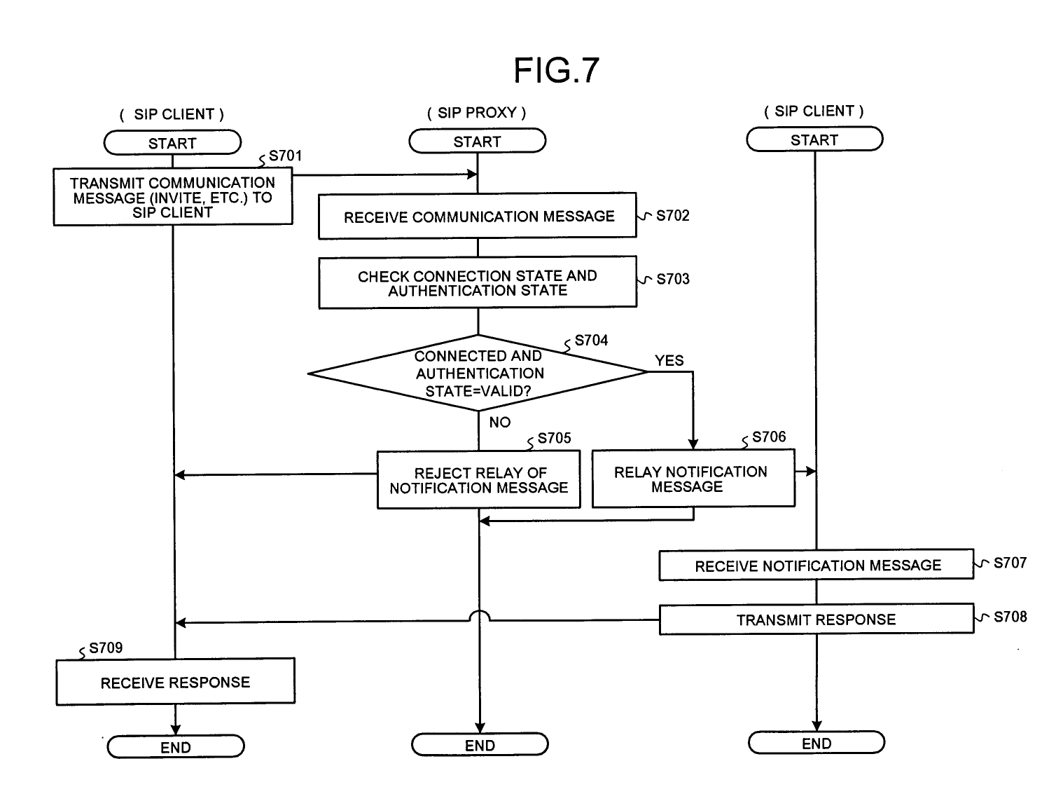

Processing performed when a signaling request for a connection state is received between the SIP clients 400 after the authentication is explained with reference to FIG. 7. In the following explanation, the SIP client 400 that transmits the signaling request is referred to as the SIP client 400a and the SIP client 400 that receives the signaling request is referred to as the SIP client 400b.

First, the SIP client 400a transmits a notification message for requesting the SIP client 400b to control a connection state to the SIP proxy 100 (step S701). The notification message means a signaling request of the SIP such as INVITE, SUBSCRIBE, MESSAGE, or BYE.

The notification receiving unit 107 of the SIP proxy 100 receives the notification message (S702). The judging unit 105 checks connection states and authentication states of the SIP clients 400a and 400b with reference to the connection information table 122 and the authentication state table 123 (step S703).

Specifically, the judging unit 105 checks, according to whether connection information between the SIP client 400a and the SIP client 400b is stored in the connection information table 122, whether the SIP clients 400a and 400b are connected. The judging unit 105 acquires authentication states corresponding to SIP URIs of the SIP clients 400a and 400b from the authentication state table 123 and checks whether both the authentication states are “valid”.

The judging unit 105 judges whether the SIP clients 400a and 400b are connected and the authentication states of the SIP clients 400a and 400b are “valid” (step S704). When the SIP clients 400a and 400b are connected and the authentication states are “valid” (“YES” at step S704), the notifying unit 108 relays the notification message to the SIP client 400b (step S706).

The SIP client 400b receives the notification message relayed (step S707) and transmits a response to the notification message received to the SIP client 400a (step S708).

When it is not judged at step S704 that the SIP clients 400a and 400b are connected and the authentication states are “valid” (“NO” at step S704), the notifying unit 108 transmits a response for rejecting relay of the notification message to the SIP client 400a (step S705).

The SIP client 400a receives the response from the SIP proxy 100 or the SIP client 400b (step S709).

However, when the SIP client 400b is not managed by the SIP proxy 100, for example, when the SIP client 400b is operated in another domain, it is conceivable that the processing for checking authentication concerning the SIP client 400b is carried out by an SIP proxy (a proxy other than the SIP proxy 100) to which the SIP client 400b is connected. In this case, it is conceivable that authentication information is exchanged between the SIP proxy 100 and the SIP proxy to which the SIP client 400b is connected. As a method of exchanging the authentication information in this case, it is possible to apply all the conventional technologies.

Once the authentication state of the SIP client 400 becomes valid in this way, in principle, the SIP proxy 100 can judge that an authentication state of the SIP client 400 is valid as long as the presence of the dialog that establishes the communication between the authentication server 200 and the SIP client 400 can be confirmed.

As a result, if it is guaranteed that the authentication server 200 correctly authenticates the SIP client 400 and correctly notifies the SIP proxy 100 of the authentication state, the SIP proxy 100 can correctly authenticate the SIP client 400 even if communication for authentication is not performed at all between the SIP client 400 and the SIP proxy 100.

When the authentication becomes invalid, if the authentication server 200 immediately notifies the SIP proxy 100 of the authentication state at a point when the authentication becomes invalid, the SIP proxy 100 can immediately detect a change in the authentication state of the SIP client 400.

Since the authentication information is transmitted and received only between the authentication server 200 and the SIP client 400, even when an authentication technology performed by using a large amount of authentication information such as image information and biological information is adopted, loads on the SIP proxy 100 is not affected.

As described above, the intermediate server according to the first embodiment can receive a result of the authentication processing executed using the communication established according to the INVITE request of the SIP from the authentication server and judge an authentication state of the communication terminal. Therefore, it is possible to authenticate the communication apparatus with low loads without depending on an amount of authentication information used for authentication and an authentication frequency.

Real-time continuous authentication is necessary to immediately invalidate an authentication state at a point when the authentication state should be invalidated. In the conventional method, the SIP proxy needs to continuously attempt authentication of the SIP client. On the other hand, in this embodiment, if the authentication server immediately transmits an authentication state to the SIP proxy, it is possible to perform real-time authentication without increasing processing loads on the SIP proxy.

In general, the SIP proxy is an apparatus that has a size equivalent to that of an electronic mail server and covers a larger number of users. The SIP proxy mediates a request from an SIP client in an authentication state and processes control, relay, and the like of signaling communication. Therefore, it is necessary to design the SIP proxy with importance placed on scalability for reducing loads of processing. Authentication information needs to be light and a communication frequency needs to be minimized.

This applies not only to the SIP but also to a communication system for a communication mediating server that intervenes among communication apparatuses and performs signaling and the communication apparatuses. However, in the conventional method, since large loads are imposed on the communication mediating server, it is impossible to use a large amount of data for authentication of the communication apparatuses and realize real-time continuous authentication.

On the other hand, according to the method of this embodiment, the communication apparatuses and the authentication server transmit and receive authentication information in communication guaranteed by the communication mediating server under the communication system represented by the SIP that interposes among the communication apparatuses and uses the signaling procedure for controlling and relaying communication. Thus, the authentication server and the communication mediating server can always keep authentication states the same according to light communication processing while making it unnecessary to transmit and receive the authentication information between the communication apparatuses and the communication mediating server.

Consequently, it is possible to reduce loads on the communication mediating server compared with the method in which the communication apparatuses and the communication mediating server exchange authentication information. It is also possible to realize an authentication state equivalent to the authentication state that is realized when the communication apparatuses and the communication mediating server exchange the authentication information. Since it is easy to exchange a large amount of authentication data, it is also possible to carry out continuous authentication processing at an arbitrary frequency. In this way, it is possible to realize authentication processing for improving security without spoiling processing and scalability peculiar to the communication mediating server.

In the first embodiment, communication between the authentication server and the SIP client is established according to the INVITE request and authentication information is transmitted and received using the communication established according to the INVITE request. For exchange of the authentication information, it is unnecessary to use the communication established according to the INVITE request in this way. It is possible to transmit and receive the authentication information according to communication established by an arbitrary method. For example, it is also possible to use a message for which a data channel is not established by a dialog like a SUBSCRIBE request used for processing of presence information in the SIP.

An intermediate server according to a second embodiment receives a result of authentication processing from the authentication server 200 and judges an authentication state of the SIP client 400. The authentication processing is executed between the authentication server 200 and the SIP client 400 by an arbitrary method and at an arbitrary frequency using direct communication of the authentication server 200 and the SIP client 400 associated with a SUBSCRIBE request of the SIP.

The direct communication associated with the SUBSCRIBE request is communication that is established between the authentication server 200 and the SIP client 400 with a method different from the dialog of SUBSCRIBE and to which information associating the communication with the SUBSCRIBE request is given. For example, it is possible to establish communication between the SIP client 400 and the authentication server 200 with arbitrary means decided in advance and associate the communication with the dialog of SUBSCRIBE by sending information such as the same user name to the SIP client 400 and the authentication server 200. It is possible to apply any other association method such as a method of sending a pair of keys of public key encryption one by one.

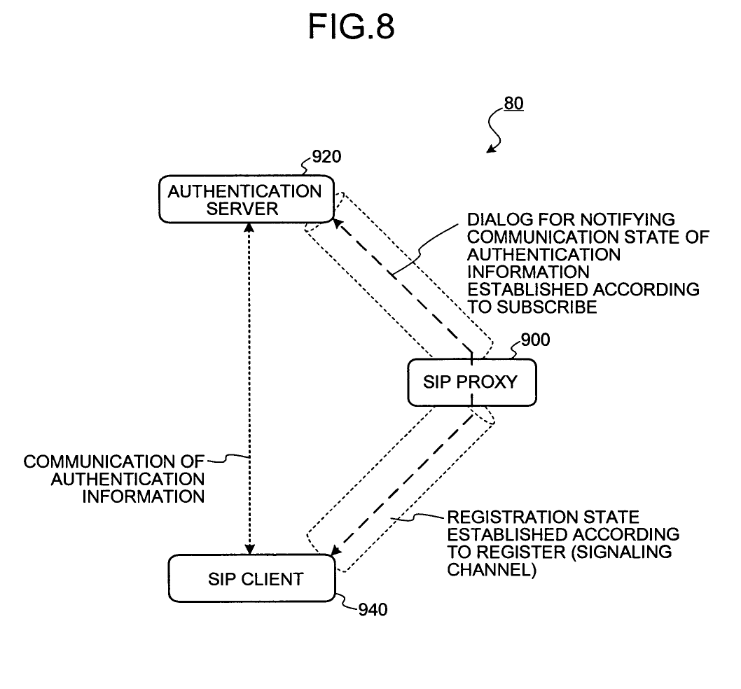

As shown in FIG. 8, a communication system 80 includes an SIP proxy 900, an authentication server 920, and an SIP client 940.

As shown in the figure, in this embodiment, authentication information is transmitted and received between the authentication server 920 and the SIP client 940 according to a SUBSCRIBE request using direct communication associated with the SUBSCRIBE request. The SIP proxy 900 receives an authentication state of the SIP client 940 from the authentication server 920 using a dialog established according to the SUBSCRIBE request.

Consequently, same as in the first embodiment, it is not necessary to transmit the authentication information from the SIP client 940 to the SIP proxy 900 and execute authentication in the SIP proxy 900. Thus, it is possible to reduce processing loads on the SIP proxy 900. Further, it is possible to realize a function same as that in the first embodiment through an arbitrary communication channel other than a data channel established according to an INVITE request.

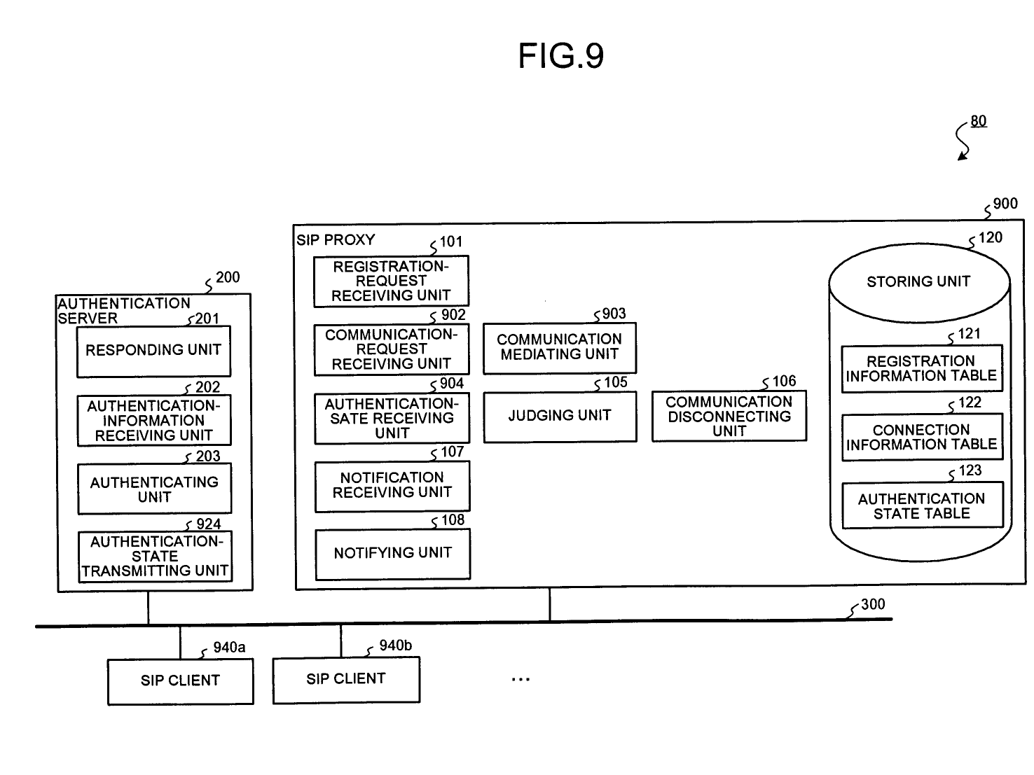

As shown in FIG. 9, in the communication system 80, the SIP proxy 900 as an intermediate server, the authentication server 920, and SIP clients 940a and 940b are connected to one another via the network 300.

In the second embodiment, a function of the SIP client 940, a function of an authentication-state transmitting unit 924 of the authentication server 920, and functions of a communication-request receiving unit 902, a communication mediating unit 903, and a function of the authentication-state receiving unit 904 in the SIP proxy 900 are different from the functions in the first embodiment. The other components and functions are the same as those shown in FIG. 2 that is the block diagram of the structure of the communication system 10 according to the first embodiment. Thus, the components are denoted by the identical reference numerals and signs and explanations of the components and the functions are omitted.

The SIP client 940 is different from the SIP client 400 according to the first embodiment in that the SIP client 940 transmits a communication request message for requesting start of communication according to a SUBSCRIBE request rather than an INVITE request.

The authentication-state transmitting unit 924 of the authentication server 920 transmits an authentication state of the SIP client 940 as a NOTIFY request of the SIP including the authentication state.

The communication-request receiving unit 902 of the SIP proxy 900 receives a SUBSCRIBE request as a communication request message for requesting start of communication from the SIP client 940 to the authentication server 920.

The communication mediating unit 903 transmits the SUBSCRIBE request received to the authentication server 920 and mediates communication between the SIP client 940 and the authentication server 920 according to a response (NOTIFY) returned from the authentication server 920. When the communication mediating unit 903 mediates the communication, the communication mediating unit 903 stores connection information concerning the communication mediated in the connection information table 122.

The authentication-state receiving unit 904 receives an authentication state of the SIP client 940 from the authentication server 920 that has started the communication. In this embodiment, the authentication server 920 transmits a NOTIFY request including the authentication state. Thus, the authentication-state receiving unit 904 receives the NOTIFY request from the authentication server 920 as an authentication state.

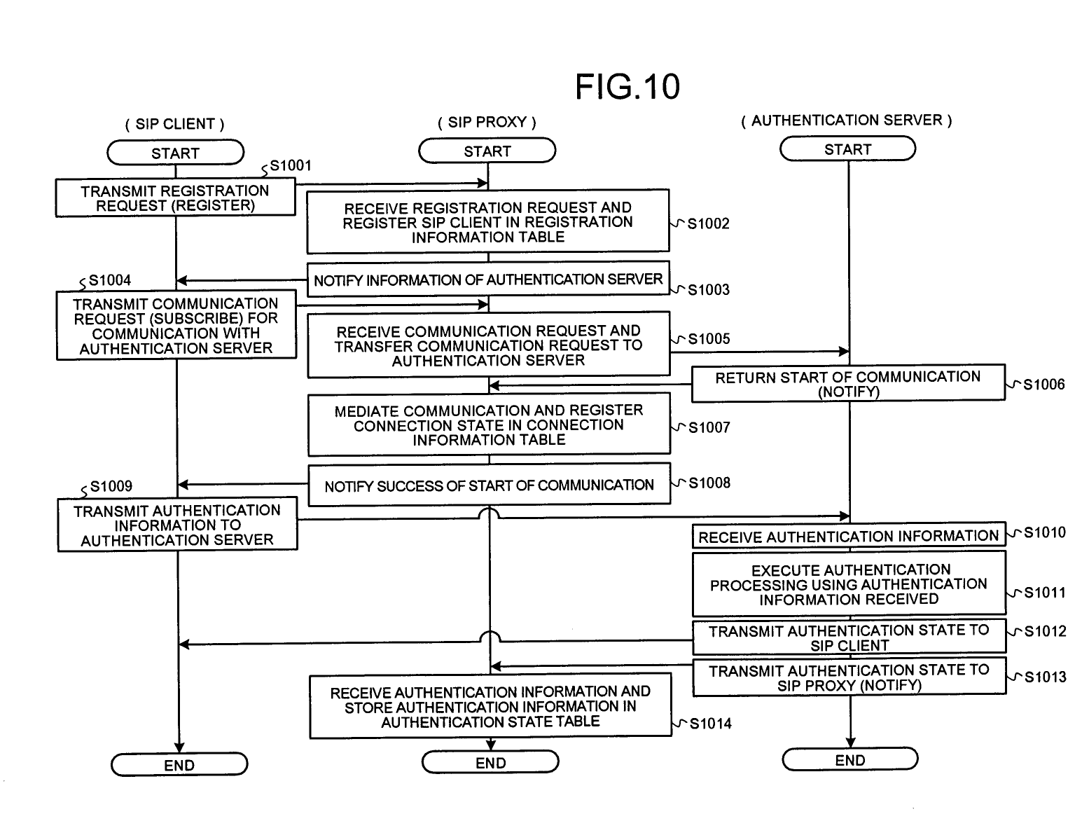

Communication mediation processing by the SIP proxy 900 according to the second embodiment constituted as described above is explained with reference to FIG. 10.

Client registration processing from step S1001 to step S1003 is the same as the processing from step S601 to step S603 in the SIP proxy 100 according to the first embodiment. Thus, explanations of the steps are omitted.

The SIP client 940 transmits a SUBSCRIBE request to the SIP proxy 900 as a communication request message for requesting start of communication between the SIP client 940 and the authentication server 920 (step S1004).

The communication-request receiving unit 102 of the SIP proxy 900 receives the SUBSCRIBE request from the SIP client 940 and transfers the SUBSCRIBE request to the authentication server 920 (step S1005).

The responding unit 201 of the authentication server 920 receives the SUBSCRIBE request and returns a response (a NOTIFY request) to the SUBSCRIBE request to the SIP proxy 900 (step S1006). Here, it is assumed that the responding unit 201 transmits a response for allowing start of communication.

The communication mediating unit 903 of the SIP proxy 900 mediates communication between the SIP client 940 and the authentication server 920 and registers connection information concerning the communication mediated in the connection information table 122 (step S1007). A connection state represented by this connection information is a dialog started according to the SUBSCRIBE request. This dialog is used for notifying a state of authentication information, which is directly communicated by the SIP client 940 and the authentication server 920, from the authentication server 920 to the SIP proxy 900.

In this embodiment, a form of direct communication between the authentication server 920 and the SIP client 940 may be any form. Authentication information is transmitted and received according to the direct communication between the authentication server 920 and the SIP client 940 connected by an arbitrary method. A result of authentication processing that uses the authentication information is transmitted from the authentication server 920 to the SIP proxy 900 via the dialog.

Success notification processing, authentication-information transmission processing, and authentication processing from step S1008 to step S1011 are the same as the processing from step S608 to step S611 in the SIP proxy 100 according to the first embodiment. Thus, explanations of the processing are omitted.

The authentication-state transmitting unit 924 transmits an authentication state to the SIP client 940 (step S1012). The authentication-state transmitting unit 924 transmits the authentication state to the SIP proxy 900 as a NOTIFY request (step S1013).

The authentication-state receiving unit 904 of the SIP proxy 900 receives the NOTIFY request and stores “valid” or “invalid” in the authentication state table 123 as an authentication state according to the authentication state included in the NOTIFY request (step S1014).

As described above, the intermediate server according to the second embodiment can receive a result of the authentication processing, which is executed by an arbitrary method and at an arbitrary frequency between the authentication server and the communication terminals using the communication started according to the SUBSCRIBE request of the SIP, from the authentication server, and judge authentication states of the communication terminals. Therefore, it is possible to transmit and receive authentication information using an arbitrary communication channel other than a data channel established according to the INVITE request.

A hardware configuration of the intermediate server according to the first or the second embodiment is explained.

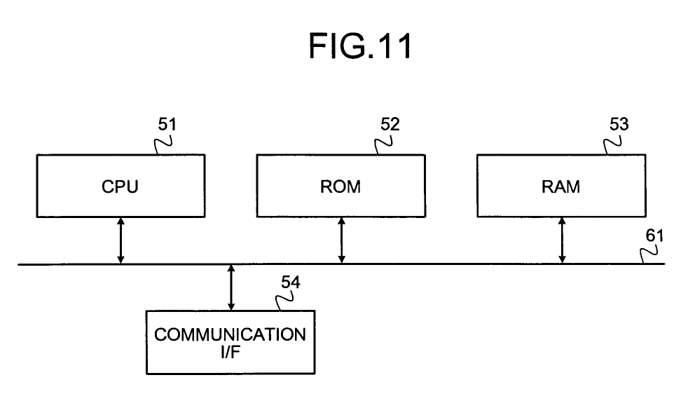

As shown in FIG. 11, the intermediate server according to the first or the second embodiment includes a control device such as a central processing unit (CPU) 51, storage devices such as a read only memory (ROM) 52 and a random access memory (RAM) 53, a communication interface (I/F) 54 for connecting the intermediate server to a network to perform communication, external storage devices such as a hard disk drive (HDD) and a compact disk (CD) drive, a display device such as a display, input devices such as a keyboard and a mouse, and a bus 61 for connecting the respective devices. The intermediate server has a hardware configuration in which a usual computer is used.

A communication mediating program executed by the intermediate server according to the first or the second embodiment is recorded in a computer-readable recording medium such as a compact disk read only memory (CD-ROM), a flexible disk (FD), a compact disk recordable (CD-R), or a digital versatile disk (DVD) as a file of an installable format or an executable format and provided.

The communication mediating program executed in the intermediate server according to the first or the second embodiment may be stored in a computer connected to a network such as the Internet and provided by being downloaded through the network. The communication mediating program executed in the intermediate server according to the first or the second embodiment may be provided or distributed through the network such as the Internet.

The communication mediating program according to the first or the second embodiment may be stored in a ROM in advance and provided.

The communication mediating program executed in the intermediate server according to the first or the second embodiment has a module configuration including the units described above (the registration-request receiving unit, the communication-request receiving unit, the communication mediating unit, the authentication-state receiving unit, the judging unit, the communication disconnecting unit, the notification receiving unit, and the notifying unit). As actual hardware, when the CPU 51 (a processor) reads out and executes the communication mediating program from the storage medium, the units are loaded onto a main storage and generated on the main storage.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An intermediate server that mediates communication between a communication terminal and an authentication server for performing authentication of the communication terminal, the intermediate server comprising:
a communication-request receiving unit configured to receive a communication request message for requesting the authentication server to start communication from the communication terminal;
a communication mediating unit configured to mediate the communication between the communication terminal and the authentication server in response to the communication request message received;
an authentication-state receiving unit configured to receive an authentication state of the communication terminal from the authentication server; and
a judging unit configured to judge success or failure of the authentication of the communication terminal based on the authentication state received.

2. The intermediate server according to claim 1, further comprising:
an authentication-state storing unit configured to store an authentication state of each of communication terminals, wherein
the judging unit is configured to judge success or failure of authentication of the communication terminal based on the authentication state stored in the authentication-state storing unit.

3. The intermediate server according to claim 2, further comprising:
a notification receiving unit configured to receive a notification message concerning communication between the communication terminals from the communication terminal; and
a first notifying unit configured to notify the notification message to the communication terminal which is a notification destination of the notification message, wherein
the judging unit is configured to acquire the authentication state of the communication terminal that has transmitted the notification message from the authentication-state storing unit, and judge success or failure of authentication of the communication terminal that has transmitted the notification message based on the authentication state acquired, and
the first notifying unit is configured to notifie the notification message to the communication terminal which is the notification destination of the notification message, when it is judged by the judging unit that the communication terminal that has transmitted the notification message is authenticated.

4. The intermediate server according to claim 1, further comprising:
a communication disconnecting unit configured to disconnect communication for the communication terminal judged as not being authenticated, when it is judged by the judging unit that the communication terminal is not authenticated.

5. The intermediate server according to claim 4, further comprising:
a connection-information storing unit configured to store connection information that is information on the communication mediated, wherein
the communication mediating unit is configured to store the connection information concerning the communication mediated in the connection-information storing unit, when communication between the communication terminal and the authentication server is mediated, and
the communication disconnecting unit is configured to delete the connection information concerning the communication disconnected from the connection-information storing unit, when communication is disconnected.

6. The intermediate server according to claim 1, further comprising:
a second notifying unit configured to notify the authentication state received from the authentication server to the communication terminal.

7. The intermediate server according to claim 1, wherein the communication-request receiving unit is configured to receive an INVITE request of a session initiation protocol (SIP) as the communication request message.

8. The intermediate server according to claim 7, wherein the authentication-state receiving unit is configured to receive a BYE request of the SIP as the authentication state at the time when the communication terminal is not authenticated.

9. The intermediate server according to claim 7, wherein the authentication-state receiving unit is configured to receive the INVITE request of the SIP as the authentication state at the time when the communication terminal is authenticated.

10. The intermediate server according to claim 1, wherein the communication-request receiving unit is configured to receive a SUBSCRIBE request of an SIP as the communication request message.

11. The intermediate server according to claim 10, the authentication-state receiving unit is configured to receive a NOTIFY request of the SIP including the authentication state.

12. The intermediate server according to claim 1, further comprising:
a registration-request receiving unit configured to receive a registration request message for requesting the communication terminal to be registered as the communication terminal that requests mediation of communication, from the communication terminal; and
a third notifying unit configured to notify information on the authentication server to the communication terminal, when the registration request message is received.

13. The intermediate server according to claim 1, wherein the authentication-state receiving unit is configured to receive an authentication state obtained by continuous authentication, from the authentication server that performs the continuous authentication with the communication terminal.

14. A communication mediating method for mediating communication between a communication terminal and an authentication server that performs authentication of the communication terminal, the method comprising:
receiving a communication request message for requesting the authentication server to start communication from the communication terminal;
mediating the communication between the communication terminal and the authentication server in response to the communication request message received;
receiving an authentication state of the communication terminal from the authentication server; and
judging success or failure of the authentication of the communication terminal based on the authentication state received.

15. A computer program product having a computer readable medium including programmed instructions for mediating communication between a communication terminal and an authentication server that performs authentication of the communication terminal, wherein the instructions, when executed by a computer, cause the computer to perform:
receiving a communication request message for requesting the authentication server to start communication from the communication terminal;
mediating the communication between the communication terminal and the authentication server in response to the communication request message received;
receiving an authentication state of the communication terminal from the authentication server; and
judging success or failure of the authentication of the communication terminal based on the authentication state received.
